(19) United States
(12) Patent Application Publication
(10) Pub. No.: US 2022/0176395 A1
(43) Pub. Date: Jun. 9, 2022

(54) DUAL FUNCTION MISTER AND DRINK BEVERAGE HOLDER

(71) Applicant: Hongyuan Han, New Vernon, NJ (US)

(72) Inventor: Hongyuan Han, New Vernon, NJ (US)

(21) Appl. No.: 17/540,353

(22) Filed: Dec. 2, 2021

Related U.S. Application Data
(60) Provisional application No. 63/120,922, filed on Dec. 3, 2020.

(51) Int. Cl. B05B 11/00; B65D 47/06; B65D 81/38

(52) U.S. Cl. CPC B05B 11/0086; B65D 47/065; B05B 11/3021; B05B 11/0038; B05B 11/0094; B65D 81/3841

(57) ABSTRACT

A dual-purpose container is described. The container includes a base portion defining a cavity configured to hold a liquid and a lid portion configured to retain the liquid in the base portion. The lid portion includes a drinking spout fluidly connected to the cavity, and a mister configured to atomize the liquid into a mist.

### STATEMENT REGARDING FEDERALLY SPONSORED RESEARCH OR DEVELOPMENT

N/A

### BACKGROUND OF THE INVENTION

Various embodiments relate generally to containers and, more specifically, relate to beverage containers having dual functions.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Beverage containers with drinking spouts provide means to carry liquid for consumption. These containers may insulated, for example, to keep the liquid cool on a hot day. Drinking a cool liquid can help manage heat and provide comfort. Misting devices also provide comfort on a hot day by atomize liquid that is then applied to the user. However, carrying two separate containers may be problematic.

What is needed is a way to combine the benefits of a beverage container and a mister in a single, dual-function container.

### BRIEF SUMMARY OF THE INVENTION

The below summary is merely representative and non-limiting.

The above problems are overcome, and other advantages may be realized, by the use of the embodiments.

In a first aspect, an embodiment provides a dual-purpose container. The container includes a base portion defining a cavity configured to hold a liquid and a lid portion configured to retain the liquid in the base portion. The lid portion includes a drinking spout fluidly connected to the cavity, and a mister configured to atomize the liquid into a mist.

### BRIEF DESCRIPTION OF THE SEVERAL VIEWS OF THE DRAWINGS

Aspects of the described embodiments are more evident in the following description, when read in conjunction with the attached Figures.

FIG. 1 shows various beverage containers in accordance with an embodiment.

FIG. 2 shows another view of the beverage containers of FIG. 1.

FIG. 3 shows a further view of the beverage containers of FIG. 1.

FIG. 4 shows a beverage container in accordance with an embodiment.

FIG. 5 shows the beverage container of FIG. 4 with the spout closed.

FIG. 6 shows a top-down view of the beverage container of FIG. 4 with the spout closed.

FIG. 7 shows a top-down view of the beverage container of FIG. 4 with the spout open.

FIG. 8 shows a close-up view of the beverage containers of FIG. 1.

FIG. 9 shows an exploded view of a beverage container in accordance with an embodiment.

FIG. 10 shows a cut-out view of the beverage containers of FIG. 9.

FIG. 11 shows cut-out views of the beverage containers of FIG. 9.

FIGS. 12 and 13 show close-up, cut-out views of the beverage containers of FIG. 9

FIG. 14 shows a close-up view of a cap for the beverage containers of FIG. 9.

FIG. 15 shows the internal side of the cap for the beverage containers of FIG. 9.

### DETAILED DESCRIPTION OF THE INVENTION

This patent application claims priority from U.S. Provisional Patent Application No. 63/120,922, filed Dec. 3, 2020, the disclosure of which is incorporated by reference herein in its entirety.

Various embodiments provide a container, and in particular to a beverage container having dual functions. A first function is to receive and selectively dispense drink beverages to a user through a manually operable spout. A second function is to serve as a selectively operable mister. The container may be filled with water to serve both as the beverage to be consumed through the spout and as a liquid to be misted.

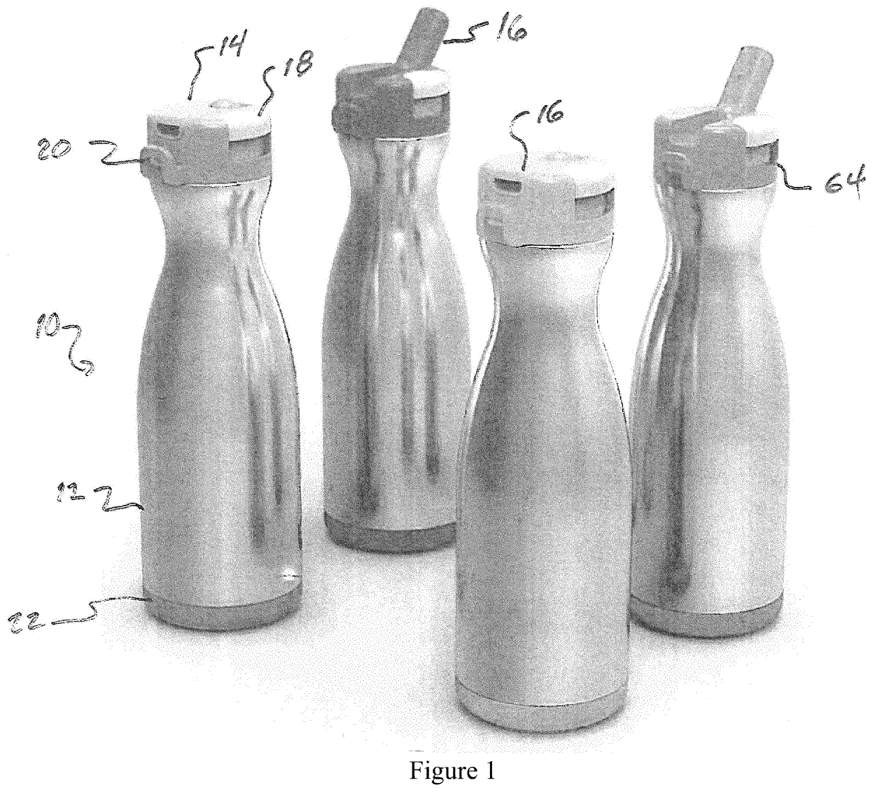

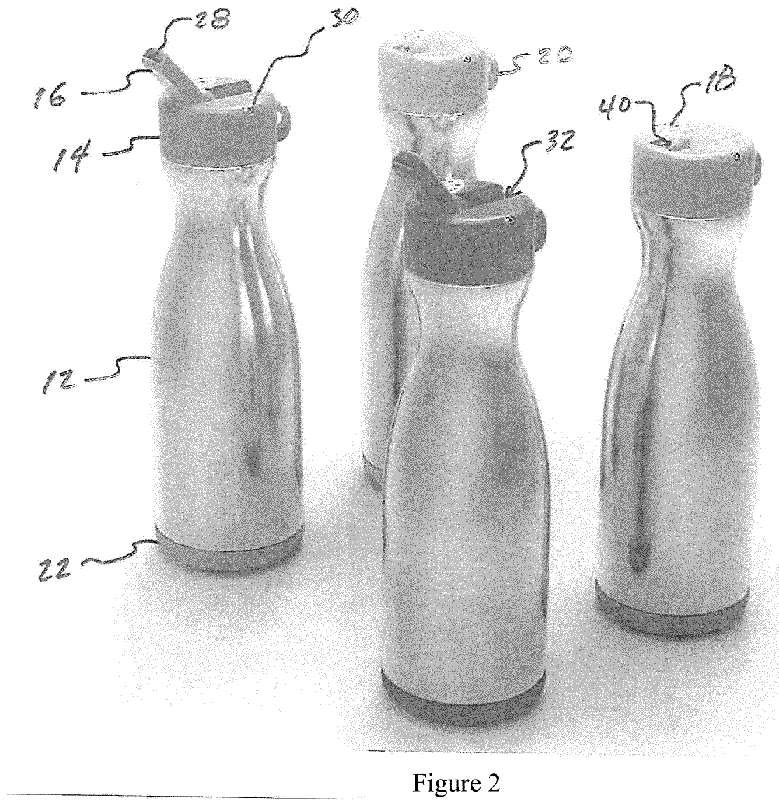

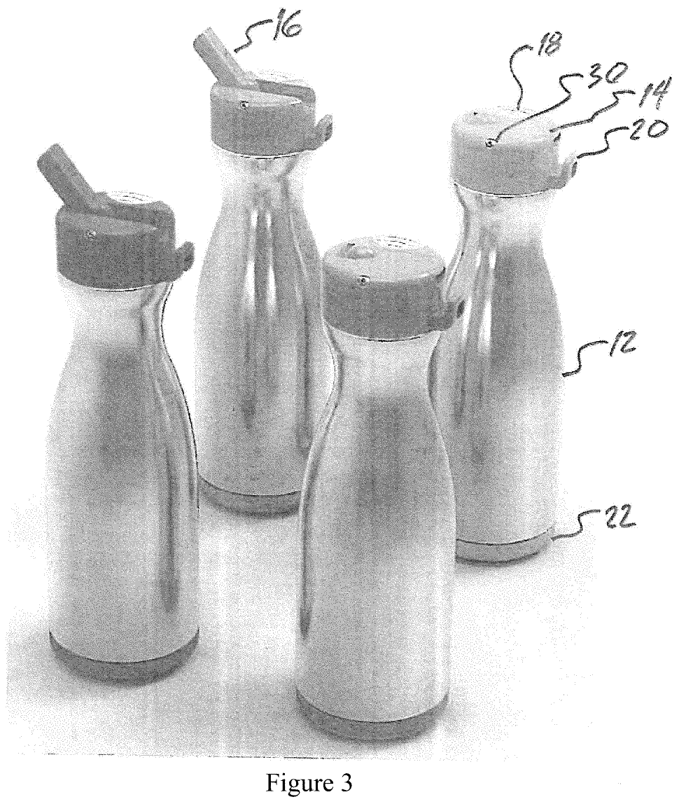

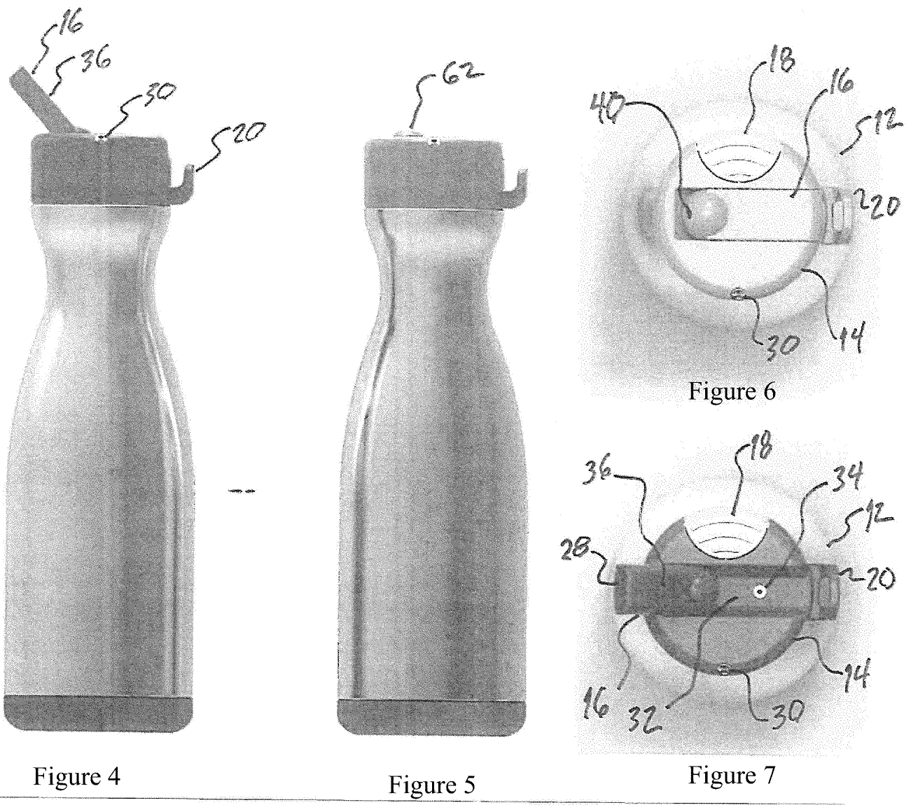

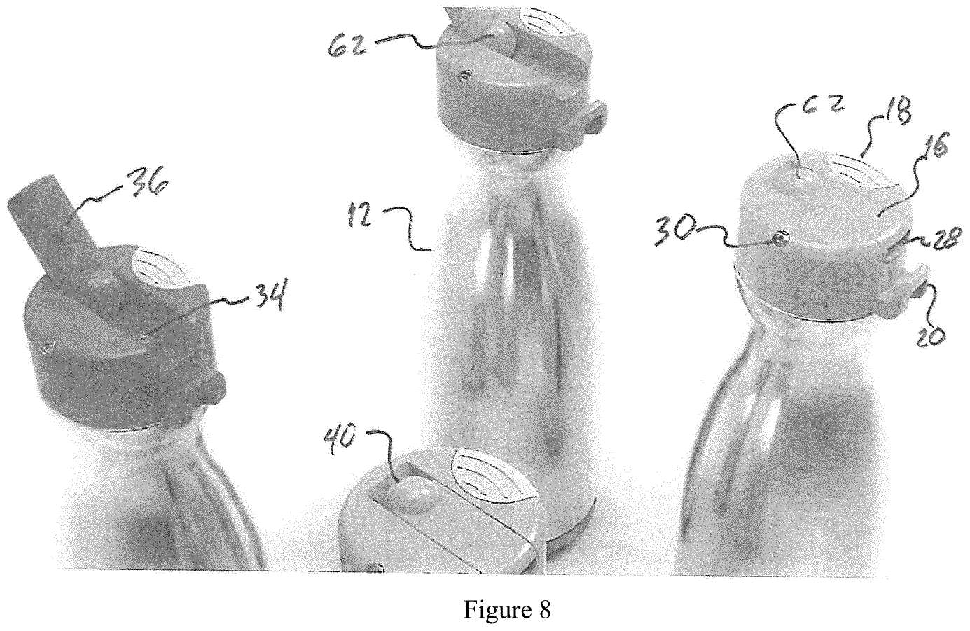

FIGS. 1-3 and 8 shows various beverage containers in accordance with an embodiment. FIGS. 4-7 and 9 show a single container 10. The container 10, in a first embodiment, is comprised of three major portions: a main body portion 12, a base portion 22, and a dual function lid portion 14.

The main body portion 12 may be comprised of one of multiple materials, including stainless steel, one of a variety of plastics, or any other rigid or semi-rigid material. Stainless steel has particular advantages including ease of cleaning, resistance to absorption of elements of fluid contents, durability, and light weight. The main body portion 12 is illustrated as having a circular vertical projection and a tapered neck region to be easily grasped by a user. However, other physical implementations may be utilized, including a simple cylinder.

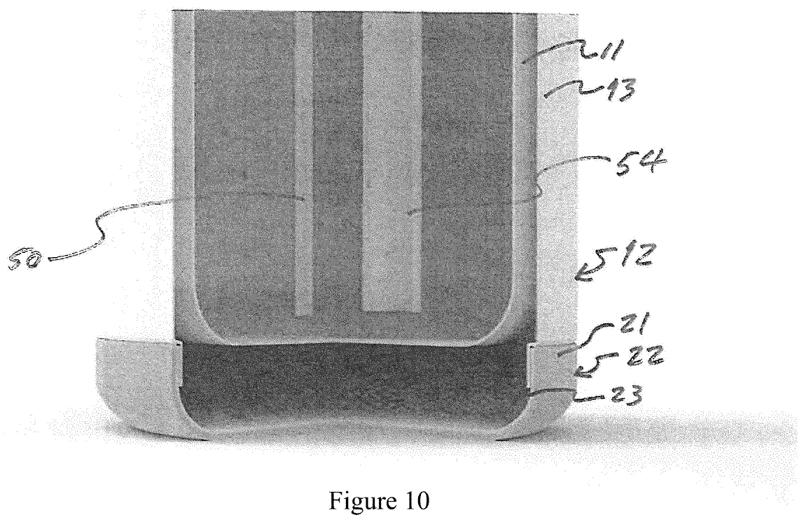

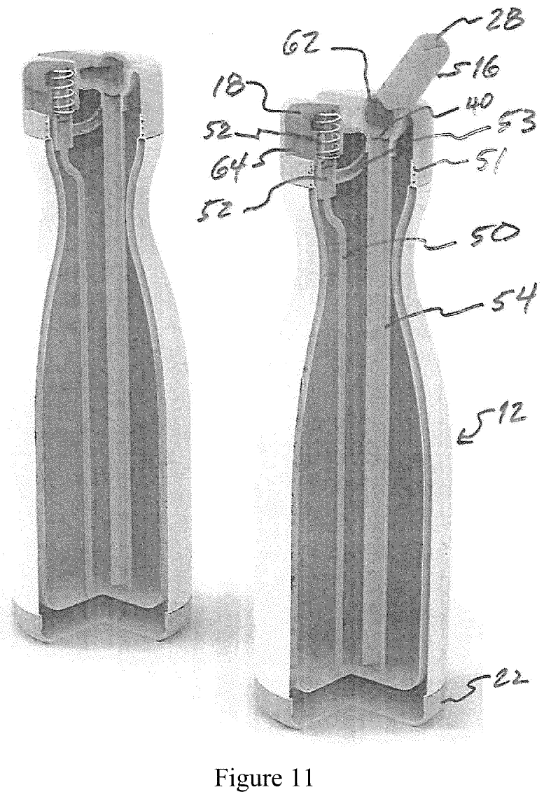

As illustrated in FIGS. 10-13, the main body portion 12 is comprised of an outer container 13 and an inner container 11. A vacuum is preferably formed between the inner and outer containers 11, 13 for better insulative performance. The inner and outer containers 11, 13 are joined at an upper extent of the main body portion 12 and are formed into an outwardly facing set of threads 49 for cooperating with inwardly facing threads 51 formed in the lid portion 14.

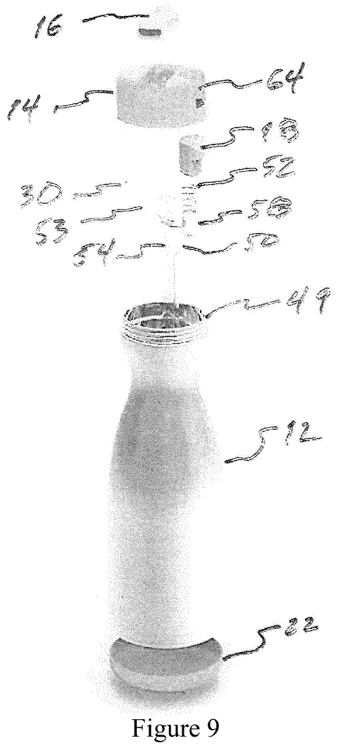

The base portion 22 is shown, such as in FIGS. 9-11, as having a plastic outer portion 21 disposed on an inner metal portion 23. Such a base portion 22 provides a resilient, dent-resistant outer material for absorbing the shock of impact with hard surfaces onto which the container 10 is placed, while still having the inner rigidity necessary to be stable when resting on a planar surface. The plastic outer portion 21 can also be provided in one or more colors according to the preference of a designer or user. The base portion 22 as illustrated is fixedly attached to the outer container 13 of the main body portion 12 such as through gluing or welding.

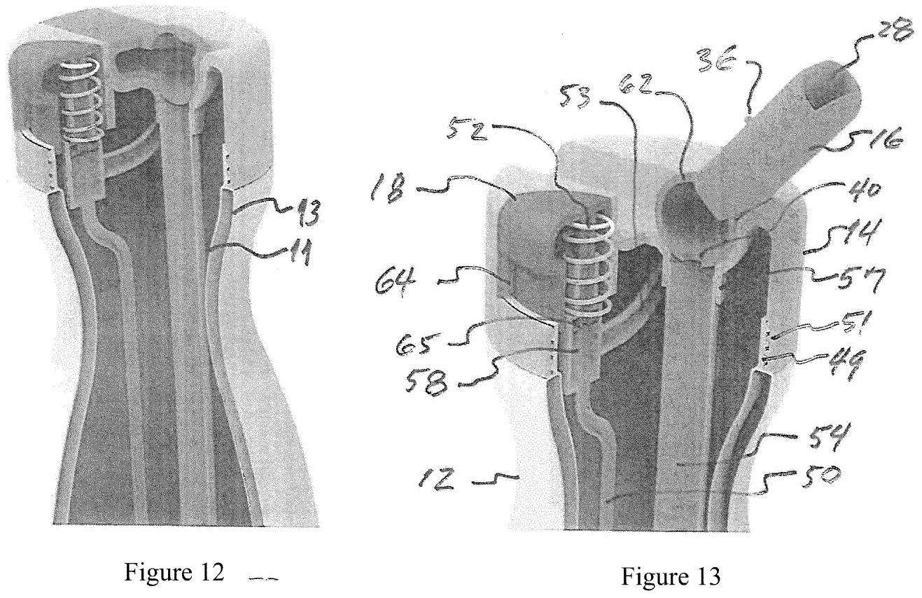

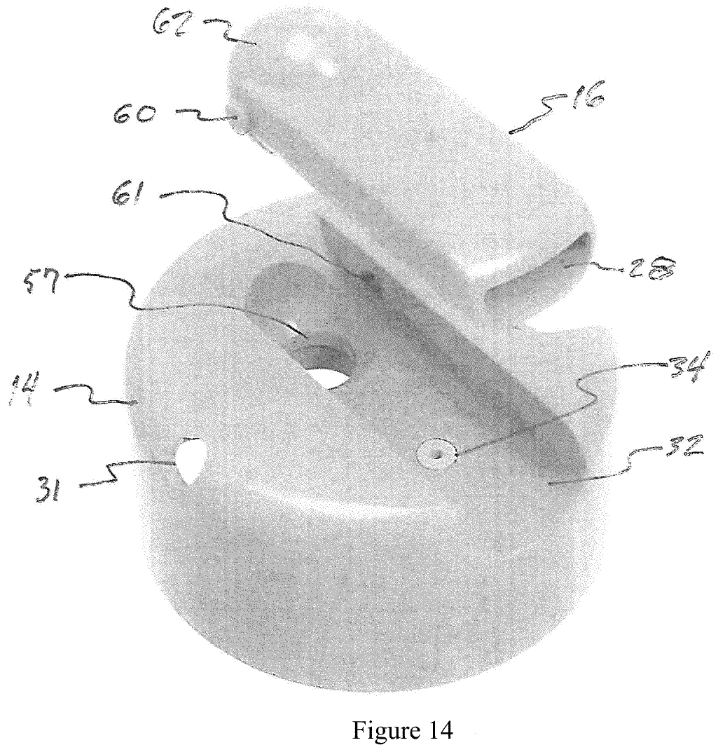

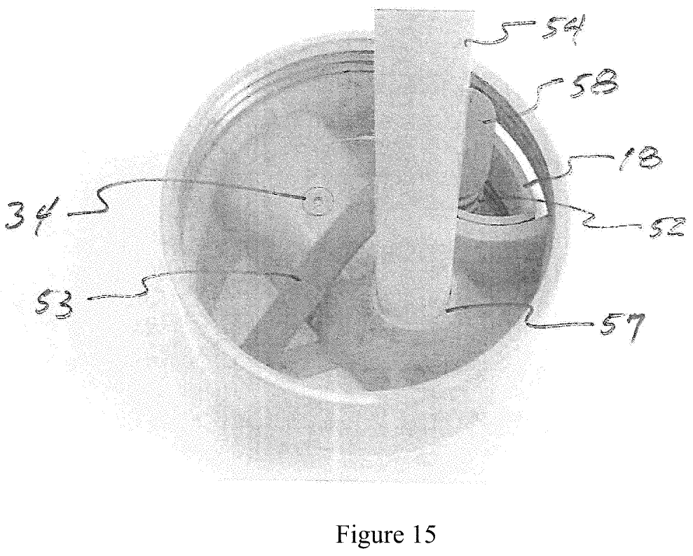

The lid portion 14 is shown in FIG. 12-15 as being formed of plastic. Plastic provides a number of advantages. It is resilient and capable of absorbing shock resulting from impact with hard surfaces. It is easily cleaned and lightweight. It is not highly thermally conductive. It is easily molded or formed through conventional techniques. It may be provided in one or more colors according to the desire of a designer or user. It enables moving parts to be fitted together through temporary part deformation, as will be discussed in greater detail below.

The lid portion 14 comprises a number of constituent elements, including a rotatable spout portion 16, a slot 32 for selectively receiving the spout portion, a pushbutton 18, a mister 30 disposed within a respective port 31, and in one illustrated embodiment an optional strap attachment point 20. The lid portion 14 is provided with inwardly facing threads 51 that mate with complimentary outwardly facing threads 49 disposed at the top of the main body portion 12. Such threads 49, 51 enable liquid and/or ice to be introduced into the container or to be drained from the container, and for the container interior to be cleaned.

The rotatable spout portion 16 has a closed position in which it is substantially parallel to a flat upper surface of the lid portion 14. The spout portion 16 also has a deployed position in which it has been rotated about a pivot 60, disposed within pivot receptacles 61 in the lid portion 14, past ninety degrees and to approximately one-hundred thirty-five degrees with respect to the closed position. Other embodiments employ a spout portion 16 that rotates to different degrees. The end of the spout portion 16 proximate the pivot 60 is provided with a ball-shaped interface 62. The ball-shaped interface 62 has an aperture 40 that is aligned with one end of an underlying supply conduit 54, via an opening 57 in the lid portion 14, when the spout portion 16 is in the deployed position. The aperture 40 is in fluid communication with a liquid channel 28 formed within the length of the spout portion 16. Thus, when then spout portion 16 is in the deployed position, a user may apply suction to the liquid channel 28 at one end of the spout portion 16, forming a vacuum therein, through the aperture 40, and within the supply conduit 54, thus drawing liquid up from the lower extent of the container 10 and out the liquid channel 28 into a user's mouth. A pressure relief aperture 34 is also formed in the lid portion 14 to allow the interior pressure within the container 10 to equalize with atmospheric pressure as liquid is drawn out through the spout portion.

When the spout portion 16 is in the closed position, the aperture 40 formed in the ball-shaped interface 62 is rotated out of alignment with the supply conduit 54 and the ball-shaped interface 62 presents a solid surface to the supply conduit 54, thereby sealing off the supply conduit 54 and preventing liquid from exiting the container 10. A post 36 formed on the spout portion 16 is aligned with the pressure relief aperture 34 when the spout portion is in the closed position, thereby sealing off the pressure relief aperture 34.

The slot 32 formed in the top of the lid portion 14 is dimensioned to receive the rotatable spout portion 16 when the latter is in the closed position. In other words, an upwardly projecting surface of the spout portion 16 is substantially parallel with the lid portion 14 upper surface, except for the previously described ball-shaped interface 62 with aperture 40. A distal end of the rotatable spout portion 16, having the liquid channel 28 opening therein, is also substantially aligned with an radially outward surface of the lid portion 14. The purpose of these aligned surfaces is to avoid projections that could be caught on clothing or other surfaces. Other configurations, including a rotatable spout portion 16 projecting above or radially outward of the lid portion, are employable for the presently disclosed container 10.

The pushbutton 18 is disposed adjacent the slot 32 on the upper surface of the lid portion 14. In the illustrated embodiment, the pushbutton 18 is formed of plastic that has a contrasting color from that of the remainder of the lid portion 14 so as to be easily identified and located by a user. The illustrated pushbutton 18 is also provided with arcuate projections on an upper surface thereof. These projections are intended to assist a user in better engaging the pushbutton 18 when downward pressure is applied, particularly when the pushbutton 18 surface is wet. The pushbutton 18 is adapted for downward movement when depressed by a user. A cutout 64 is provided in the side of the lid portion 14 to accommodate the path of travel of the pushbutton 18. Underneath the pushbutton 18 is a coil spring 52 axially aligned with the pushbutton 18 downward path of travel. The spring 52 resists downward pressure and returns the pushbutton 18 to an upper, neutral position in which the upper surface of the pushbutton 18 is substantially flush or even with the upper surface of the lid portion 14. Mechanical stops may be provided on the pushbutton 18 and/or lid portion 14 to prevent the pushbutton 18 from traveling too far upward. Mechanical retainers may be used to keep the pushbutton 18 within the lid portion, or the physical configuration of the cutout and the pushbutton 18 itself may suffice to keep the pushbutton 18 within the lid portion 14.

A piston 65 projecting downwardly from the underside of the pushbutton 18 is mechanically and fluidly connected to a mister conduit 50 via a one-way valve 58 disposed within an underside of the lid portion 14. The connection between the mister conduit 50 and the one-way valve 58 may be temporary, such as via friction fit, in order that the mister conduit 50 may be removed for cleaning. A mister supply tube 53 is also in mechanical and fluid communication with the one-way valve 58 and terminates in the mister 30. In use, initial downward pressure on the pushbutton 18 compresses the coil spring 52 and forces air out of the one-way valve 58, through the mister supply tube 53, and out the mister 30 itself. Once a lower extent of travel of the pushbutton 18 has been reached, a user releases the downward pressure and the pushbutton 18 returns to the upper, neutral position through decompression of the coil spring 52. This introduces negative pressure into the one-way valve 58 that draws liquid into the mister conduit 50. Repeated actuations of the pushbutton 18 eventually result in liquid being drawn into the one-way valve 58. Once this occurs, subsequent actuations of the pushbutton 18 force liquid out of the one-way valve 58, through the mister supply tube 53, and out the mister 30 into the atmosphere adjacent the container 10.

The mister 30 is preferably formed of a metal insert in order to achieve the desired misting functionality; plastic may also be molded into a mister 30 in order to provide the desired misting functionality. The mister 30 is configured to atomize liquid as it exits the mister 30 under pressure from the downward movement of the pushbutton 18.

The foregoing description has been directed to particular embodiments. However, other variations and modifications may be made to the described embodiments, with the attainment of some or all of their advantages. Modifications to the above-described systems and methods may to be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A container comprising:
a base portion defining a cavity configured to hold a liquid; and
a lid portion configured to retain the liquid in the base portion;
wherein the lid portion includes: a drinking spout fluidly connected to the cavity, and a mister configured to atomize the liquid into a mist.

2. The container of claim 1, wherein the lid portion further comprises a pushbutton configured to draw the liquid from the base portion into the mister in response to being pressed downward.

3. The container of claim 1, wherein the drinking spout is rotatable around a pivot from a closed position sealing the liquid in the base portion and an open position allowing the liquid to be drawn through the spout.

4. The container of claim 1, further comprising a strap attachment point.

5. The container of claim 1, wherein the base portion comprises a dual-walled cylinder.

6. The container of claim 5, wherein the dual-walled cylinder is vacuum insulated.

7. The container of claim 1, wherein the base portion is comprised, at least in part, of stainless steel.

8. The container of claim 1, wherein the lid portion is comprised, at least in part, of plastic.

9. The container of claim 1, wherein the lid portion further comprises: a first conduit fluidly connected to the drinking spout and a second conduit fluidly connected to the mister.

10. A container lid configured to retain a liquid in a cavity defined by a base portion, the container lid comprising:
a drinking spout fluidly connected to a cavity; and
a mister configured to atomize the liquid into a mist.

11. The container lid of claim 10, further comprising a pushbutton configured to draw the liquid from the base portion into the mister in response to being pressed downward.

12. The container lid of claim 10, wherein the drinking spout is rotatable around a pivot from a closed position sealing the liquid in the base portion and an open position allowing the liquid to be drawn through the spout.

13. The container lid of claim 10, further comprising a strap attachment point.

14. The container lid of claim 10, wherein the container lid is comprised, at least in part, of plastic.

15. The container lid of claim 10, further comprising a first conduit fluidly connected to the drinking spout and a second conduit fluidly connected to the mister.
